(19) United States
(12) Patent Application Publication
(10) Pub. No.: US 2007/0076256 A1
(43) Pub. Date: Apr. 5, 2007

(54) Image forming apparatus and method of the same

(75) Inventors: Norihiro Yamamoto, Numazu-shi (JP); Toshiharu Takahashi, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/228,073

(22) Filed: Sep. 16, 2005

(51) Int. Cl. G06K 15/00

(52) U.S. Cl. 358/1.16; 358/1.15

(57) ABSTRACT

When a USB memory 10 is set to a host USB port 8a and back-up processing is set on a control panel 4, data in the hard disk drive 25 is read out based on a program in the USB memory 10 and stored in the USB memory 10. The data read out from the hard disk drive 25 can also be stored in a CD-R drive 15 set to a host USB port 8b. When, on the other hand, the USB memory 10 and CD-R drive 15 are set to the USB ports 8a, 8b and restore processing is set on a control panel 4, the data in the USB memory 10 or CD-R drive 15 is read out based on the program in the USB memory 10 and it is stored in the hard disk drive 25.

### BACKGROUND OF THE INVENTION

1. Field of the Invention

The present invention relates to a composite type image forming apparatus having a plurality of functions and its control method.

2. Description of the Related Art

Known is a composite type image forming apparatus (MFP) having a plurality of functions such as a scan function and network print function in addition to an ordinary copying function.

Such a composite type image forming apparatus has a mounted hard disk drive for storing image data, etc. Further, the hard disk drive has various kinds of registered set data indispensable to the operation of the image forming apparatus and stored database (DB) for management. The database has registered address book data having a set of network addresses, a fax-transmit phone numbers, etc., for another image forming apparatus.

Where a plurality of such apparatuses are mounted as image forming apparatuses, it is necessary to register the above-mentioned set data and database for all the image forming apparatuses. The register processing is manually done one by one by service personnel. This manual operation imparts a larger burden to the service personnel.

It may be considered that the set data and database registered on one image forming apparatus are transferred/registered onto remaining image forming apparatuses via a network such as a LAN.

In the register processing via such a network, a terminal (personal computer) of the service personnel is connected to the same network. For the respective image forming apparatus and an enterprise possessing their own network, the connecting of the service personnel (an outsider) terminal to the network owned by the enterprise is not allowed from the standpoint of security.

### BRIEF SUMMARY OF THE INVENTION

In an aspect of the present invention, an image forming apparatus and its control method are provided which allow data necessary to respective image forming apparatuses to be readily and positively registered without importing any burden to service personnel and not via a network.

In one aspect of the present invention, there is provided an image forming apparatus comprising a data memory section, an external memory medium configured to store a program for reading data out of the data memory section, a port configured to allow the external memory medium to be set thereto, an operation section configured to set back-up processing and restore processing, a first control section configured to, when the external memory medium is set to the port and the back-up processing is set by the operation section, read data out of the data memory section based on the program in the external memory medium and store the read-out data into the external memory medium, and a second control section configured to, when the external memory medium is set to the port and the restore processing is set by the operation section, read the data out of the memory medium based on the program in the external memory medium and store the read-out data into the data memory section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a perspective view showing an outer appearance of an embodiment of the present invention;

FIG. 2 is a view showing an arrangement of a control panel of the embodiment of the present invention;

FIG. 3 is a block diagram of a control circuit of the present embodiment;

FIG. 4 is a flowchart for explaining the operation of the present embodiment;

FIG. 5 is a view showing a particular mode set image screen in the present embodiment;

FIG. 6 is a view showing a processing set image screen in the present embodiment;

FIG. 7 is a view showing a data select image screen in the present embodiment;

FIG. 8 is a view showing a memory medium select image screen in the present embodiment; and

FIG. 9 is a view showing another practical form of a memory medium select image screen in the present embodiment.

### DETAILED DESCRIPTION OF THE INVENTION

With reference to the accompanying drawing, an explanation will be made below about one embodiment of the present invention.

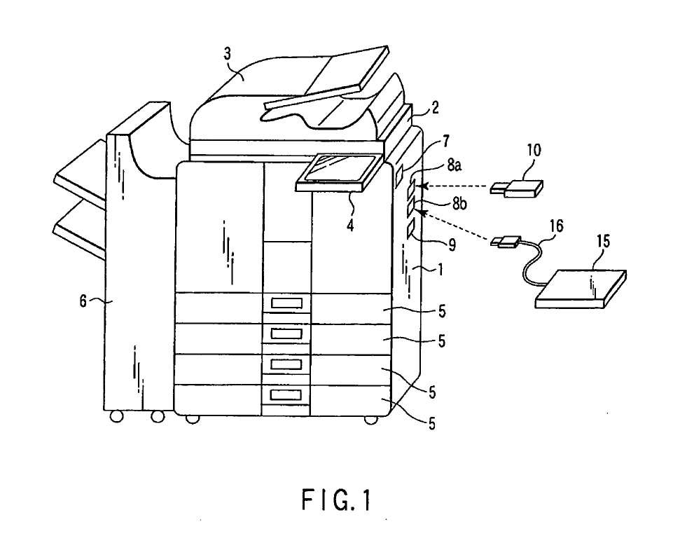

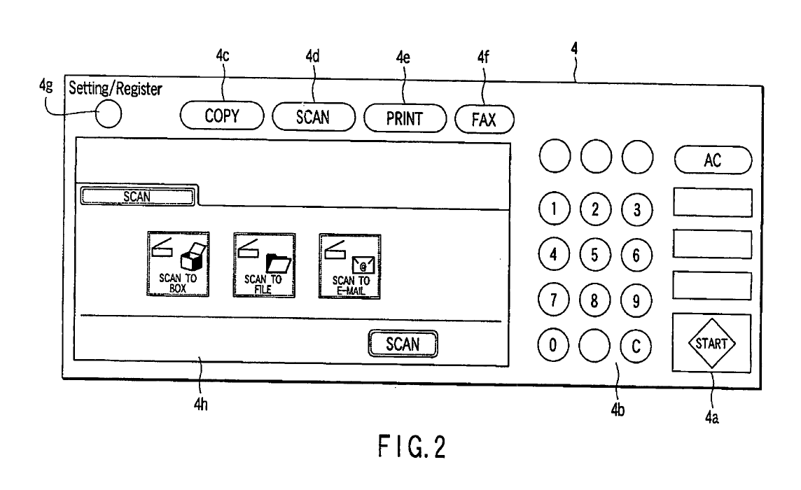

As shown in FIG. 1, a document sheet rest 2 is provided on the upper section of a body 1 of an image forming apparatus and an auto document feeder (ADF) 3 is so provided as to be opened and closed. At the same height level as that of the document sheet rest, a control panel 4 shown in FIG. 2 is provided as an operation means. On the control panel 4, a start key 4a, ten keys 4b, a copy key 4c, a scan key 4d, a print key 4e, a FAX key 4f, a setting/register key 4g, a touch-panel type liquid-crystal display image screen 4h, etc., are provided.

A plurality of cassettes 5 each with a corresponding size and kind of paper sheets stored in it are provided below the lower section of the apparatus body 1. A paper sheet discharge unit 6a is provided at one side section of the apparatus body 1 to allow the paper sheet which has been printed to be received in it.

At the other side section of the apparatus body 1, a power supply switch 7, USB ports 8a, 8b for a host and a USB port 9 for a device are provided. With respect to the USB ports 8a and 8b a set of the USB memory 10 and CD-R drive 15 is provided, the USB memory 10 serving as a first external memory medium and the CD-R drive 15 serving as an example of a large capacity memory device serving as a second external memory medium. As the large capacity memory device use can be made of not only the CD-R drive 15 but also a hard disk drive, an MD drive, a DVD drive, etc.

It is to be noted that, as the main function of the apparatus body, there are a scan function and a network print function. As the scan function there are a SCAN to BOX function for allowing image data which is scanned in the apparatus body 1 to be stored in a hard disk drive 25 as will be described later, a SCAN to FILE function for allowing the image data which is scanned in the apparatus body 1 to be stored in personal computers 41, 42, etc., as will be described below, and a SCAN to E-MAIL function for allowing the image data which is scanned in the apparatus body 1 to be sent in an e-mail form to the external device. The network print function serves to allow the image data which is sent from the external device to the apparatus body 1 to be printed at the apparatus body 1.

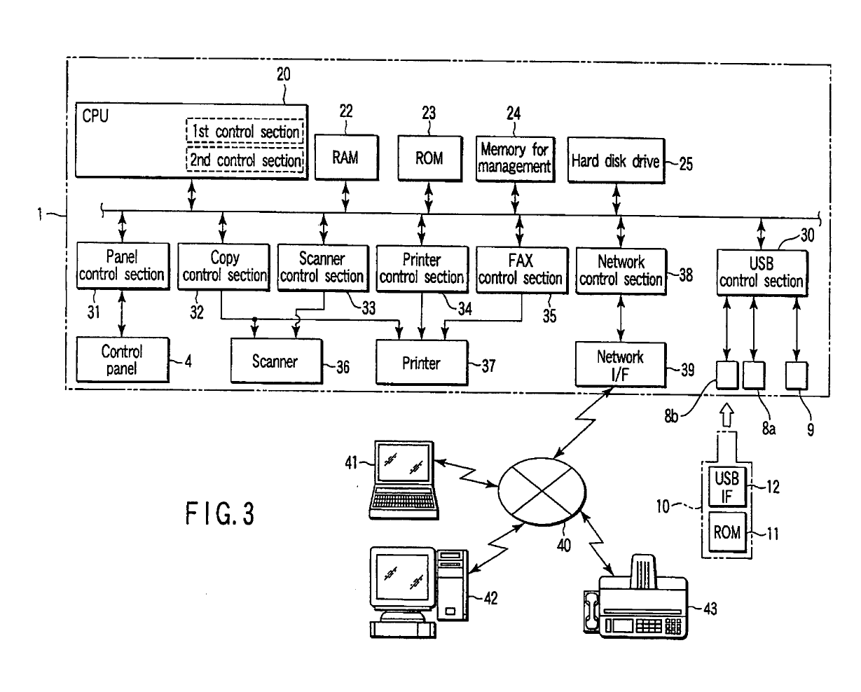

As shown in FIG. 3, the apparatus body 1 includes a CPU 20 serving as a main controller. To the CPU 20 are connected a RAM 22, a ROM 23, a nonvolatile memory 24 for management, a hard disk drive 25 serving a large capacity data memory section, a USB control section 30, a panel control section 31, a copy control section 32, a scanner control section 33, a printer control section 34, a facsimile (FAX) control section 35 and a network control section 38.

The USB control section 30 allows the reading-in of the data from the USB memory 10 and external memory medium to the host USB ports 8a and 8b and allows the storing of data in the USB memory 10 and external memory medium. A ROM 11 stores in it a program, that is, a load module, which reads data out of the hard disk drive 25. Further, the ROM 11 allows data other than the load module to be stored in a remaining portion of it.

The RAM 22 is used to store various kinds of data in it. The ROM 23 is used to store in it various kinds of control programs necessary to the operation of the body 1. The memory 24 for management stores, in it, data for the management of the apparatus body 1. The hard disk drive 25 allows image data scanned in the apparatus body 1, and image data, etc., from another image forming apparatus, to be stored in it and allows database (DB), address book data, set data, etc., to be stored in it. The address book data comprises a set of network address of an associated external forming apparatus, fax-transmit phone numbers, and so on, and constitutes a portion of the database. The set data are such as language setting data of the control panel 4, language setting data of Web utilities, IP address data, and so on, which are indispensable to the operation of the body 1.

The panel control section 31 controls the control panel 4. The copy control section 32 controls a normal copying function using a scanner 36 and printer 37. The scanner control section 33 controls a scanning function (SCAN to BOX function, SCAN to FILE function and SCAN to E-MAIL function) using the scanner 36. The printer control section 34 controls a network print function using a printer 37. The facsimile control section 35 controls a facsimile function using the printer 36.

The network control section 38 controls the transmitting and receiving of the data to and from the associated external device via the network interface 39. A network interface 39 includes a LAN board, a FAX modem, etc., and is connected via an external communication circuit line 40 to associated external devices such as the personal computers 41, 42 and facsimile equipment 43.

CPU 20 has a first control section and a second control section.

The first control section has the following control means indicated by (1) and (2) below.

(1) Control means which, when the USB memory 10 is set to the USB port 8a for a host and back-up processing is set on the control panel 4, allows read- and code-processing to be performed on data initially selected by the control panel 4 out of data in the hard disk 25, on the basis of a program in the USB memory 10, and stores the coded data in the USB memory 10.

(2) Control means which, when the USB memory 10 and CD-R drive 15 are set to the USB ports 8a and 8b for a host and back-up processing is set on the control panel 4, allows read-and code-processing to be performed on data initially selected by the control panel 4 out of data in the hard disk drive 25, on the basis of a program in the USB memory 10, and stores the coded data in any of the USB memory 10 and CD-R drive 15. Which coded data is stored in any of the USB memory 10 and CD-R drive 15 is initially selected by the operation of the control panel 4.

The second control section has the following control means indicated by (1) and (2) below.

(1) Control means which, when the USB memory 10 is set to the USB port 8a for a host and restore processing is set on the control panel 4, allows read- and decode-processing to be performed on data initially selected by the control panel 4 out of data stored in the USB memory 10, on the basis of a program in the USB memory 10, and stores the decoded data in the hard disk drive 25.

(2) Control means which, when the USB memory 10 and CD-R drive 15 are set to the USB ports 8a and 8b for a host and restore processing is set on the control panel 4, allows read-and decode-processing to be performed on data stored in any of the USB memory 10 and CD-R drive 15, on the basis of the program in the USB memory 10, and stores the decoded data in the hard disk drive 25, From which USB memory 10 and CD-R drive 15 the data is read out is initially selected by the operation of the operation panel 4.

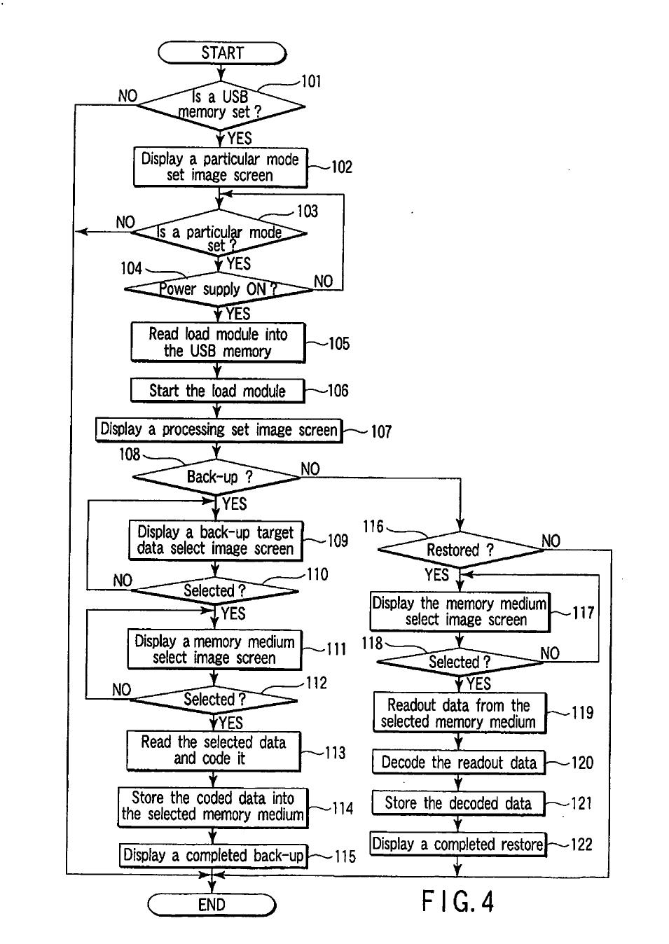

With reference to the flowchart of FIG. 4, the operation will be explained below.

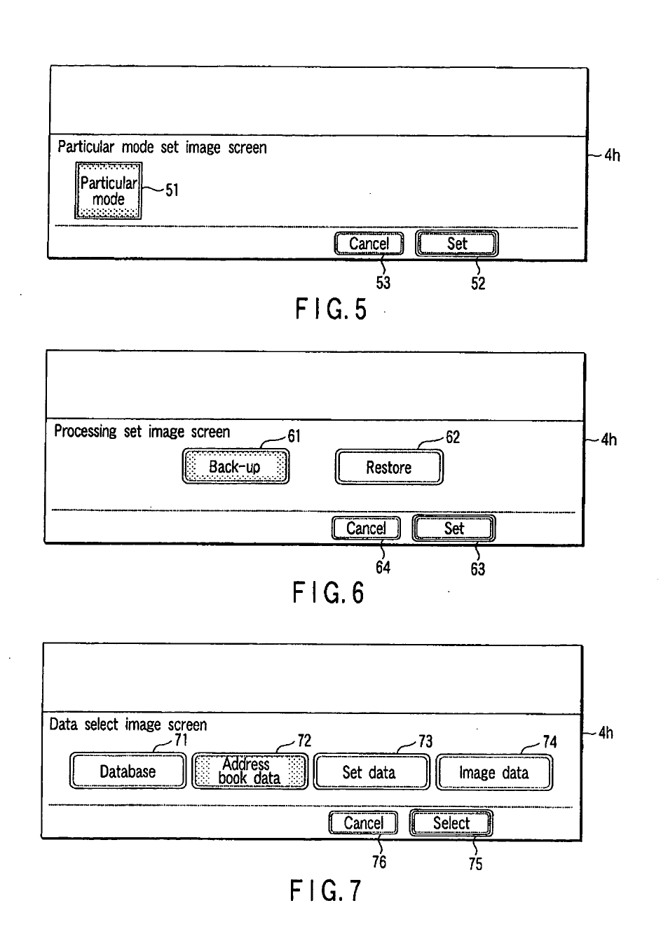

When the USB memory 10 possessed by service personnel is set to the USB port 8a for a host (YES at step 101), a “particular mode set image screen” shown in FIG. 5 is displayed on a liquid-crystal display image screen 4h of the control panel 4. A particular mode button 51, a setting button 52 and cancel button 53 are displayed on the “particular mode set image screen”.

If the particular mode button 51 is touch-operated by the service personnel, the particular mode button 51 is lit. The lit state is represented by dots. In this state, the particular mode is set by the touch operation of the setting button 52 (YES of step 103).

When the particular mode is set (YES of step 103) and the power supply switch 7 of the apparatus body 1 is turned ON (step 104), the load module (program) stored in the USB memory 10 is read into the apparatus body 1 via the USB port 8a for a host (step 105). The read-in load module is stored into RAM 22 and started (step 106).

By the starting of the load module, a “processing set image screen” shown in FIG. 6 is displayed on the liquid crystal display image screen 4h of the control panel 4. A back-up button 61, a restore button 62, a setting button 63 and a cancel button 64 are displayed on the “processing set image screen”.

When the back-up button 61 is touch-operated by the service personnel, the back-up button 61 is lit and the lit state is represented by the dots. By performing a touch-operation in this state, the back-up processing is set (YES at step 108).

When the back-up processing is set (YES at step 108), a “data select image screen” as shown in FIG. 7 is displayed on the liquid crystal display image screen 4h of the control panel 4. On the data select image are displayed a database button 71, an address book data button 72, a setting data button 73, an image data button 74, a select button 75 and a cancel button 76 corresponding to the data (a database, address book data, setting data, image data in the hard disk drive 25) as a back-up target.

When the address book data button 72 is touch-operated by the service personnel, the address book data button 72 is lit. The lit state is represented by dots. By the touch-operating the select button 75 in this state, the address book data is selected (YES at step 110).

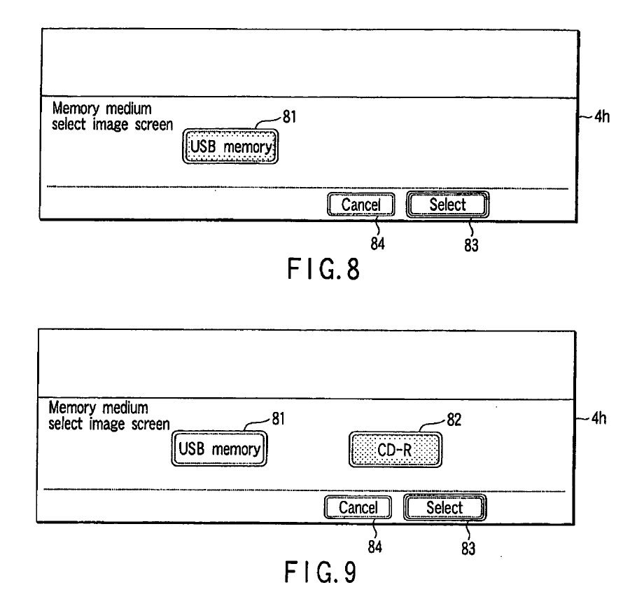

When the address book data is selected (YES at step 110), a “memory medium select image screen” as shown in FIG. 8 is displayed on the liquid crystal display image screen 4h of the control panel 4. In this case, since only the USB memory 10 is set to the USB ports 8a, 8b for a host, that is, only the USB memory 10 is detected, the USB memory button 81, select button 83 and cancel button 84 are displayed on the “memory medium select image screen”.

When the USB memory button 81 is touch-operated by the service personnel, the USB memory button 81 is lit and the lit state is indicated by dots. By the touch-operation of the select button 83 in this state, the USB memory 10 is selected (YES at step 112).

Then, the selected address book data is read out from the hard disk drive 25 and stored in RAM 22. And the address book data in the RAM 22 is coded (step 113). This coding is done by a coding program initially stored in the ROM 23.

The coded data is stored in the selected USB memory 10 (step 114). When this storing is completed, the back-up completed character is displayed on the liquid crystal display image screen 4h of the control panel 4 (step 115) and this back-up processing is completed.

By looking at the back-up completed character display, the service personnel judges that the address book data is stored in the USB memory 10. And the USB memory 10 is reset from the USB port 8a for a host.

It is to be noted that, where the USB memory 10 and CD-R drive 15 are set to the USB port 8a and 8b for a host, a “memory medium select image screen” shown in FIG. 9 is displayed on the liquid crystal display image screen 4h of the control panel 4 after the address book data has been selected (YES at step 110). That is, since the USB memory 10 and CD-R drive 15 are detected, a USB memory button 81, a CD-R button 82, a select button 83 and cancel button 84 are displayed on the “memory medium select image screen”.

When the CD-R button 82 is touch-operated by the service personnel, the CD-R button 82 is lit. By the touch operation of the select button 83 in this state, the CD-R drive 15 is selected (YES at step 112).

Subsequently, the selected address book data is read from the hard disk drive 25 and stored in the RAM 22. And the address book data in the RAM 22 is coded (step 113).

The coded data is stored in the selected CD-R drive 15 (step 114). When the storing of the coded data is completed, the back-up completed character is displayed on the liquid crystal display image screen 4h (step 115). This completes the back-up processing.

By looking at the back-up completed character display, the service personnel judges that the address book data is stored in the CD-R drive 15. And the USB memory 10 and CD-R drive 15 are reset from the USB ports 8a and 8b for a host.

After the back-up processing is completed, the service personnel moves a newly installed image forming apparatus and the USB memory 10 is set to a USB port 8a for a host, that is, a USB port 8a of the image forming apparatus.

When the USB memory 10 is set to the USB port 8a for a host (YES at step 101), a “particular mode set image screen” as shown in FIG. 5 is displayed on the liquid crystal display image screen 4h of the control panel 4. When the particular mode button 51 of the “particular mode set image screen” is touch-operated by the service personnel, the particular mode button 51 is lit. By the touch-operation of the setting button 52 in this state, a particular mode is set (YES at step 103).

When the particular mode is set (YES at step 103) and the power supply switch 7 of the apparatus body 1 is turned ON (step 104), a load module (program) is read into the apparatus body 1 via the USB port 8a for a host (step 105). The thus read load module is stored in the RAM 22 and started (step 106).

By the starting of the load module, a “processing set image screen” as shown in FIG. 6 is displayed on the liquid crystal display image screen 4h of the control panel 4. When the restore button 62 on the “processing set image screen” is touch-operated by the service personnel, the restore button 62 is lit. By the touch-operation of the setting button 63 in this state, the restore processing is set (NO at the step 108, YES at step 116).

When the restore processing is set (YES at step 116), the “memory medium select image screen” as shown in FIG. 8 is displayed on the liquid crystal display image screen 4h of the control panel 4 (step 117). When the USB memory button 81 of the “memory medium select image screen” is touch-operated, the USB memory button 81 is lit. By the touch-operation of the select button 83 in this state, the USB memory 10 is selected (YES at step 118).

When the USB memory 10 is selected (YES at step 118), the address book data stored in the USB memory 10 is read out (step 119). The thus read out address book data is stored in the RAM 22. And the address book data in the RAM 22 is decoded (step 120). This decoding is done under a decode program initially stored in the ROM 23.

The decoded data is stored in the hard disk drive 25 (step 121). When this data storing is completed, a restore completed character is displayed on the liquid crystal display image screen 4h of the control panel 4 (step 122). In this way, the restore processing is completed.

By looking at the restore completed character display, the service personnel judges that the address book data is stored in the hard disk drive 25 of the apparatus body 1, and the USB memory 10 is reset from the USB port 8a for a host.

It is to be noted that, where the USB memory 10 and CD-R drive 15 are set to the USB ports 8a and 8b for a host, the “memory medium select image screen” as shown in FIG. 9 is displayed on the liquid-crystal display image screen 4h of the control panel 4 after the restore processing has been set (YES at step 116). That is, since the USB memory 10 and CD-R drive 15 are detected, the USB memory button 81, CD-R button 82, select button 83 and cancel button 84 are displayed on the “memory medium select image screen”.

When the CD-R button 82 is touch-operated by the service personnel, the CD-R button 82 is lit. By the touch-operation of the select button 83 in this state, the CD-R drive 15 is selected (YES at step 112).

When the CD-R drive 15 is selected (YES at step 118), the address book data stored in the CD-R drive 15 is read out (step 119). The thus read-out address book data is stored in the RAM 22. And the address book data in the RAM 22 is decoded (step 120).

The decoded data is stored in the hard disk drive 25 (step 121). When this data storing is completed, the restore completed character is displayed on the liquid crystal display image screen 4h (step 122). In this way, the restore processing is completed.

By looking at the restore-completed character display, the service personnel judges that the address book data is stored in the hard disk drive 25 of the apparatus body 1. And the USB memory 10 and CD-R drive 15 are reset from the USB ports 8a and 8b for a host.

When, as set out above, the USB memory 10 is set to the host USB port 8a and back-up processing is set on the control panel 4, data in the hard disk drive 25 is read out based on the program in the USB memory 10 and stored in the USB memory 10. The data which is read out from the hard disk drive 25 can also be stored in the CD-R drive 15 set to the USB port 8b.

Where the USB memory 10 and CD-R drive 15 are set to the USB ports 8a and 8b and restore processing is set on the control panel 4, data stored in the USB memory 10 or CD-R drive 15 is read out based on the program in the USB memory 15 and stored in the hard disk drive 25.

The data stored in one image forming apparatus is readily and positively copied/registered on another image forming apparatus through the USB memory 10 (and CD-R drive 15). It is not necessary for the service personnel to perform any cumbersome manual registering operation. It is thus possible to alleviate any larger burden on the service personnel.

The data stored in one image forming apparatus can be readily and positively copied/registered on another image forming apparatus without use of the network. Further, it is not necessary for the service personnel to connect his or her terminal (personal computer) to the network. It is also possible to prevent any outside leakage of important data on the network and to obtain high security.

Since the data in the hard disk drive 25, after being coded, is read out of the apparatus body 1 and the read-out data, after being decoded, is registered into the body 1, it is possible to prevent any risk of data leakage and also to obtain a high security level.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image forming apparatus comprising;
a data memory section;
an external memory medium configured to store a program for reading data out of the data memory section;
at least one port configured to allow the external memory medium to be set thereto;
an operation section configured to set back-up processing and restore processing;
a first control section configured to, when the external memory medium is set to the port and the back-up processing is set by the operation section, read data out of the data storing section based on a program in the external memory medium and store the data in the external memory medium; and
a second control section configured to, when the external memory medium is set to the port and the restore processing is set by the operation section, read data out of the external memory medium based on the program in the external storage medium and store the read-out data in the data memory section.

2. An apparatus according to claim 1, wherein the data memory section is comprised of a hard disk drive, the external memory medium is comprised of a USB memory, and the port is comprised of a USB port.

3. An apparatus according to claim 1, wherein the first control section is configured to, when the external memory medium is set to the port and the back-up processing is set by the operation section, read the data out of the data memory section based on the program in the external memory medium and code the data and store the coded data in the external memory medium, and the external control section is configured to, when the external memory medium is set to the port and the restore processing is set by the operation section, read the data out of the external memory medium based on the program in the external memory medium and decode the data and store the decoded data into the data memory section.

4. An apparatus according to claim 1, wherein the data in the data memory section comprises a database, address book data, set data indispensable to the operation of the apparatus, and image data.

5. An apparatus according to claim 4, wherein the operation section sets the back-up processing and restore processing and selects any of data in the data memory section.

6. An apparatus according to claim 5, wherein the first control section is configured to, when the external memory medium is set to the port and the back-up processing is set by the operation section, read out selected data from the data memory section, based on the program in the external memory medium, and store the read-out data into the external memory medium, the selected data being selected by the operation section.

7. An apparatus according to claim 5, wherein the first control section is configured to, when the external memory medium is set to the port and the back-up processing is set by the operation section, read out selected data from the data memory section, based on the program in the external memory medium, and code the read-out data, and store the coded data in the external memory medium, the selected data being selected by the operation section.

8. An image forming apparatus comprising:
a data memory section;
a first external memory medium configured to store a program for reading data out of the data memory section;
a second external memory medium;
a plurality of ports configured to allow the corresponding external memory mediums to be set thereto;
an operation section configured to set back-up processing and restore processing;
a first control section configured to, when the corresponding external memory mediums are set to the ports and the back-up processing is set by the operation section, read the data out of the data storing section, based on the program in the first external memory medium, and store any of the external memory mediums; and
a second control section configured to, when the external memory mediums are set to the ports and the restore processing is set by the operation section, allow any of the data which are stored in the external memory mediums to be read out based on the program in the first external memory medium and store the data in the data storing section.

9. An apparatus according to claim 8, wherein the data memory section is comprised of a hard disk drive, the first external memory medium is comprised of a USB memory, the second external memory medium is comprised of a large capacity memory device, and each port is comprised of a USB port.

10. An apparatus according to claim 8, wherein the first control section is configured to, when the external memory mediums are set to the corresponding ports and the back-up processing is set by the operation section, read the data out of the data memory section based on the program in the first external memory medium and code the read-out data, and store the coded data in any of the external memory mediums, and the second control section is configured to, when the external memory medium is set to the corresponding ports and the restore processing is set by the operation section, read out any of the data of the external memory mediums, based on a program in the first external medium, and decode the data, and store the decoded data in the data storing section.

11. An apparatus according to claim 8, wherein the data in the data memory section comprises a data base, address book data, set data indispensable to the operation of the apparatus, and image data.

12. An apparatus according to claim 11, wherein the operation section sets the back-up processing and restore processing and selects any of data in the data memory section.

13. An apparatus according to claim 12, wherein the first control section is configured to, when the external memory mediums are set to the corresponding ports and the back-up processing is set by the operation section, read out selected data from the data memory section based on the program in the first external memory medium, and store any of the external memory mediums, the selected data being selected by the operation section.

14. An apparatus according to claim 12, wherein the first control section is configured to, when the external memory mediums are set to the corresponding ports and the back-up processing is set by the operation section, read out selected data from the data memory section based on the program in the first external memory medium and code the read-out data and store the coded data in any of the external memory mediums, the selected data being selected by the operation section.

15. An apparatus according to claim 11, wherein the operation section sets the back-up processing and restore processing and selects any data in the data memory section and any data in the external memory medium.

16. An apparatus according to claim 15, wherein the first control section is configured to, when the external memory mediums are set to the corresponding ports and the back-up processing is set by the operation section, read out selected data from the data memory section based on a program in the first external memory medium and store the read-out selected data in one of the external memory mediums which is selected by the operation section, the selected data in the data memory section being selected by the operation section.

17. An apparatus according to claim 15, wherein the first control section is configured to, when the external memory mediums are set to the corresponding ports and the back-up processing is set by the operation section, read out the data from the data memory section based on a program in the first external memory medium and code the read-out data and store the coded data into a selected one of the external memory mediums which is selected by the operation section, said read-out data being selected by the operation section.

18. A control method of an image forming apparatus comprising a data memory section, an external memory medium configured to store a program of reading data out of the data memory section, at least one port configured to allow the external memory medium to be set thereto, and an operation section configured to set the back-up processing and restore processing, the method comprising:
a step of, when the external memory medium is set to the port and back-up processing is set by the operation section, reading out the data from the data memory section based on a program in the external memory medium and storing the read-out data in the external memory medium; and
a step of, when the external memory medium is set to the port and the restore processing is set by the operation section, reading the data out of the external memory medium and storing the read-out data into the data memory section.

19. An image forming apparatus comprising:
data memory means;
external memory means for storing a program of reading data out of the data memory means;
at least one setting means for setting the external memory means;
operation means for setting back-up processing and restore processing;
first control means for, when the external memory means is set to said at least one setting means and the back-up processing is set by the operating means, reading data out of the data memory means based on the program in the external memory means and storing the read-out data into the external memory means; and
second control means for, when the external memory means is set to the setting means and the restore processing is set by the operation means, reading the data out of the external memory means based on the program in the external memory means and storing the read-out data into the data memory means.
